(19) United States
(12) Patent Application Publication
(10) Pub. No.: US 2006/0171153 A1
(43) Pub. Date: Aug. 3, 2006

(54) Light distribution for headlights of vehicles

(75) Inventor: Wolfgang Peitz, Warstein (DE)

Correspondence Address: BIRCH STEWART KOLASCH & BIRCH, PO BOX 747, FALLS CHURCH, VA, 22040-0747, US

(73) Assignee: Hella KGaA Hueck & Co., Lippstadt (DE)

(21) Appl. No.: 11/346,157

(22) Filed: Feb. 3, 2006

Related U.S. Application Data
(63) Continuation of application No. PCT/EP05/01050, filed on Feb. 3, 2005.
(60) Provisional application No. 60/655,015, filed on Feb. 22, 2005.

(51) Int. Cl. B60Q 1/06

(52) U.S. Cl. 362/465; 362/467; 362/468

(57) ABSTRACT

In a light distribution for headlights, whereby the at least one vehicle headlamp is comprised of an optical element imaging the light of a light source, a housing, and a transparent cover disk; the light distribution includes a bright-dark-border, and various light functions are generated by adjusting the light distribution; the bright-dark-border extends essentially horizontally in the area of the roadway to be illuminated in order to realize various light functions with only one light distribution and a headlamp construction that is as simple and economical as possible; the light distribution in the central area directly below the bright-dark-border, which extends essentially horizontally, has a high intensity; the bright-dark-border of the light distribution is essentially symmetrical; and the various light functions are generated by a vertical adjustment of the light distribution.

This nonprovisional application is a continuation of International Application PCT/EP05/001050, which was filed on Feb. 3, 2005. This nonprovisional application also claims priority on Provisional Application No. 60/655,015, which was filed in the United States on Feb. 22, 2005, and which is herein incorporated by reference.

### BACKGROUND OF THE INVENTION

1. Field of the Invention

The present invention relates to a light distribution for headlights of vehicles, whereby the at least one vehicle headlight includes an optical element imaging the light of a light source, a housing, and a transparent cover disk, the light distribution has a bright-dark-border, and various light functions can be generated by adjusting the light distribution.

2. Description of the Background Art

From German publication DE 197 18 540 A1, a reflector for a vehicle headlamp is known. This reflector generates a light distribution with a distinct bright-dark-border. By adjusting the light distribution in a horizontal and vertical direction, different light functions are generated. The disadvantage of this prior art is that both a vertical and a horizontal adjustment is necessary to activate the various light functions due to a light spot pointing upwards beyond the bright-dark-border of the light distribution. An asymmetric array of the light distribution in relation to the roadway to be illuminated thus becomes necessary in order to avoid blinding drivers in oncoming traffic.

### SUMMARY OF THE INVENTION

It is therefore an object of the present invention to provide various light functions with only one light distribution, and a headlamp construction that is as simple and economical as possible.

A benefit of the present invention, whereby the bright-dark-border is essentially horizontal in the area of the roadway to be illuminated, is that blinding drivers in oncoming traffic remains impossible as long as the bright-dark-border is adjusted below the horizontal zero line.

The benefit of the feature, whereby the light distribution has a high intensity in a central area directly below the essentially horizontal bright-dark-border, is that the headlamp of the vehicle has a high range of coverage and a distinct bright-dark-border, thus providing optimum illumination of distant areas of the roadway.

A benefit of the feature, whereby the bright-dark-border of the light distribution is essentially symmetric is that no glare to oncoming traffic is generated in any driving condition. Another benefit is that the basic light-defining components of the vehicle headlamps, which typically are mounted to the vehicle at least in pairs, can be economically constructed as identical parts.

It is of particular benefit that the various light functions are generated by vertical adjustment of the light distribution so that only one adjustment device has to be provided in order to be able to realize all necessary light distributions, thus making an economical and simple construction of the headlamps possible.

It is thus beneficial that in the central area of the light distribution, the horizontal spread is greater than the vertical spread, whereby the light intensity directly below the bright-dark-border is entirely focused on the main distant roadway area to be illuminated, thus making a horizontal adjustability unnecessary because vehicle tolerances need not be considered.

It is beneficial in this context that the central area of the light distribution has a horizontal extension of at least 5 degrees, thus making sure that all distant roadway areas ahead of the vehicle that need to be illuminated are illuminated with a high intensity.

The benefit of the feature, whereby the central area of the light distribution has a horizontal extension of less than 15 degrees, is that both the intended size of the headlamp and the intended light output of the light source can be limited to a necessary measure, and still generate an optimum illumination of the distant area of the roadway to be illuminated.

The angles stated refer to the illustration of the light distribution as isolux lines on a wall erected 25 meters in front of the vehicle.

It is beneficial in this context that the central area is formed by at least two vehicle headlamps that complement each other in the light distribution, whereby the formation of the light distributions is complemented by a suitable fixed horizontal adjustment of the headlights.

The benefit of the feature, whereby a headlight leveling device is added to the vehicle headlamp to activate the various light functions and to adjust the light distribution vertically, is a particularly simple construction of the headlamp because such headlight leveling devices are already generally used in vehicle headlamps to adjust load-dependent position changes of the vehicle on the road.

The headlight leveling device can thereby be activated either manually or automatically, whereby a particular benefit is derived from the headlight leveling device being connected to a control device, which from switch and sensor signals generates control signals for activating and adjusting the headlight leveling device.

It is particularly beneficial in this context for headlight leveling device to be activated dynamically and in dependence from the driving conditions, so that an adjustment of the bright-dark-border can be achieved that is as exact and good as possible, thus entirely eliminating any possible glare to oncoming traffic.

Because the activation of the headlight leveling device takes place via an electrical bus (bar) of the vehicle, a particularly simple and economical construction of the vehicle headlamp and its connection to the electrical distribution system of the vehicle is achieved.

As a result of the feature, whereby in its outer area, the bright-dark-border of the light distribution extends upwards, a particularly beneficial light distribution is obtained, which yields a best possible far-reaching illumination, particularly in the lateral area of the light distribution, which provides the driver with especially good visibility, thus increasing the safety by recognizing objects and people on both sides of the roadways.

As a beneficial result of the feature, whereby in its outer area, the light distribution expands downwardly, a very wide lateral illumination of the roadway area all the way to the sides of the vehicle is achieved, so that additional curve-illuminating headlights with costly swivel mechanisms can be dispensed with.

It is particularly beneficial in this context to provide the light distribution with a large horizontal width to be able to eliminate adjustment devices for moving the light distribution horizontally.

From the feature, whereby the light distribution, depending on the adjusted vertical height in relation to the horizontal zero line, generates high beam light, low-beam light for left- and right-hand traffic with or without curve illumination, and a fog light, the benefit is derived that in a simple and economical way, all international regulations for light distributions can be satisfied with only at least one headlamp and one light distribution, and one vertically functioning adjustment device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a light distribution of the present invention in an isolux diagram on a control wall arranged 25 meters in front of the vehicle;

FIG. 2 illustrates the light distribution of the present invention with ascending outer areas;

FIG. 3 shows a light distribution of the present invention with ascending and downwardly expanding outer areas;

FIG. 4 shows the light distribution of the present invention according to FIG. 1, with a vertical adjustment for a high beam function;

FIG. 5 shows the light distribution of the present invention according to FIG. 1, with a vertical adjustment for a fog light function;

FIG. 6 shows a reflector headlight for generating the light distribution of the present invention;

FIG. 7 shows a projector headlight for generating a light distribution of the present invention.

### DETAILED DESCRIPTION

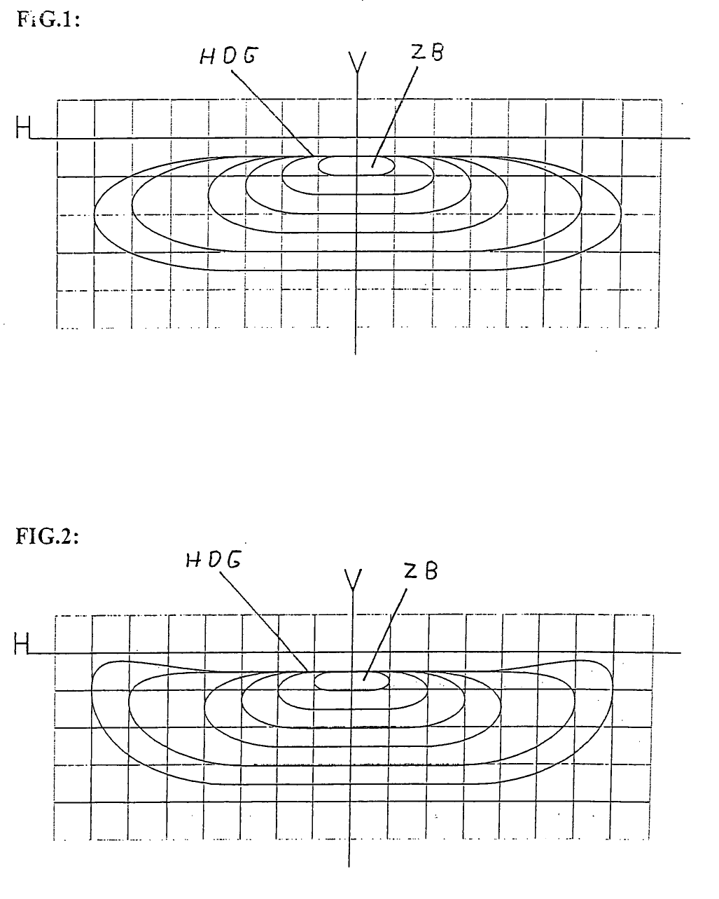

In FIG. 1, the light distribution is illustrated with an isolux diagram. As is common for technical measurements of vehicle headlights, the isolux diagram is projected on a wall, which is positioned 25 meters in front of the vehicle, thus in front of the vehicle headlights, in the direction of the headlight beams. Both the vertical zero line (V) and the horizontal zero line (H) can be seen. The grid of the wall was provided in 5-degree increments. The illustrated light distribution shows a distinct, highly defined bright-dark-border (HDG), which in this case is adjusted below the horizontal zero line (H), thus illustrating a low-beam light function. According to legal requirements for low-beam light distributions, the bright-dark-border (HDG) can be adjusted all the way to the horizontal zero line (H). However, it is common to set the bright-dark-border (HDG) with a slight tilt below the horizontal zero line. The light distribution shown in FIG. 1 has a large width so that the lateral areas of the vehicle are also optimally illuminated. Beneficially, this width is at least +/−30 degrees. In this embodiment, the bright-dark-border (HDG) extends essentially in a horizontal direction. The light distribution has thereby a high light intensity in the central area (ZB) directly below the essentially horizontal bright-dark-border (HDG). The spread in the central area (ZB) of the light distribution is thereby more horizontal than vertical.

In order to obtain optimum illumination of the roadway to be illuminated ahead of the vehicle, a horizontal extension of at least 5 degrees is needed. With a horizontal extension of less than 15 degrees, an optimum illumination of distant roadway areas ahead of the vehicle is definitely assured. Since the illustrated light distribution is typically generated by a set of two vehicle headlamps mounted in the vehicle, the central area (ZB) can also be formed by complementary, superimposed light distributions. The light distribution shown in FIG. 1 is essentially symmetric.

In FIG. 2, the basic, but slightly altered, light distribution of FIG. 1 is illustrated. In this light distribution, the bright-dark-border (HDG) is ascending lightly in the outer area. Otherwise, the light distribution also features an essentially horizontal bright-dark-border (HDG) as well as the central area (ZB) described in FIG. 1.

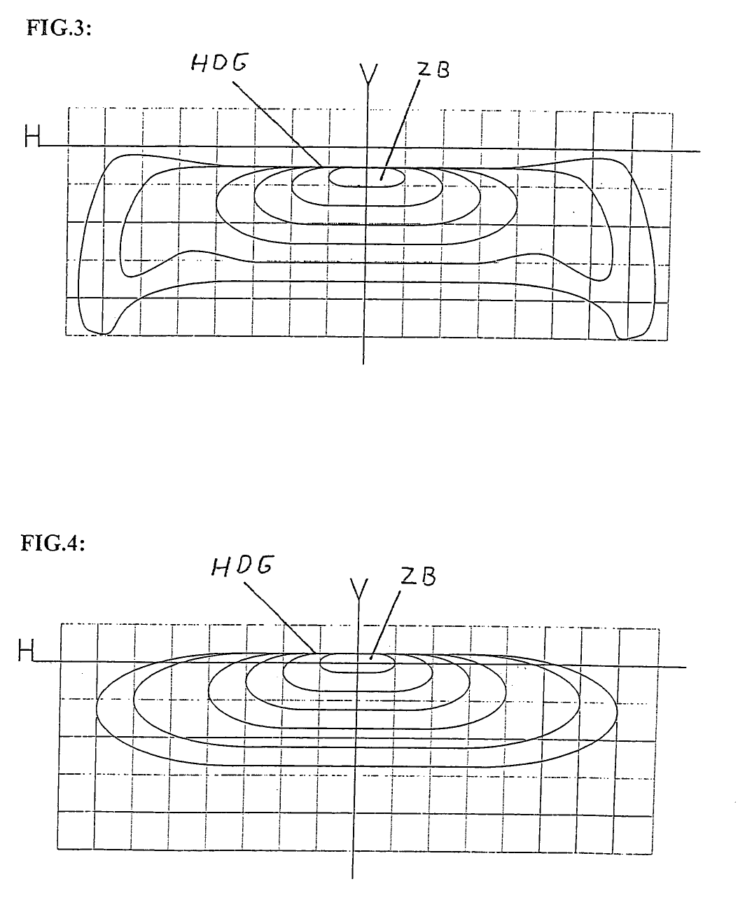

In FIG. 3, a further developed light distribution compared to FIG. 2 is illustrated. In addition to FIG. 2, this light distribution has downwardly expanding areas in the outer area. The combination of the light distribution features of FIG. 1 and the light distribution features of FIG. 2, and the expansion of the outer lower areas provide a light distribution, which cover all required light functions for all driving conditions. With the illustrated vertical adjustment of the light distribution for a low-beam light function, an optimum, non-glaring, far-reaching illumination of the lane ahead of the vehicle is assured. Due to the symmetrical design of the light distribution, blinding oncoming traffic is avoided in any driving situation; owing to the ascending areas in the outer area of the light distribution, the sides all around the vehicle are optimally illuminated; and as a result of the downwardly expanding light distribution in the outer area, an optimum curve-illuminating functionality is achieved.

In FIG. 4, the light distribution as described in FIG. 1 is illustrated, whereby the vertical adjustment of the light distribution corresponds to a high-beam function. The bright-dark-border (HDG) is hereby set above the horizontal zero line (H), essentially to obtain, through the central area (ZB), an increased range of the light distribution of the vehicle headlight.

In FIG. 5, the light distribution as described in FIG. 1 is illustrated as a fog light function. The bright-dark-border (HDG) was hereby clearly adjusted below the horizontal zero line (H). In fog and heavy rain, for example, one of the benefits derived therefrom is that the high intensities of the central area (ZB) of the light distribution do not lead to self-blinding of the driver from the light of his/her own headlights.

When functions are added, the light distributions illustrated in FIGS. 1, 4, and 5 can also be replaced with the light distributions shown in FIGS. 2 and 3, respectively.

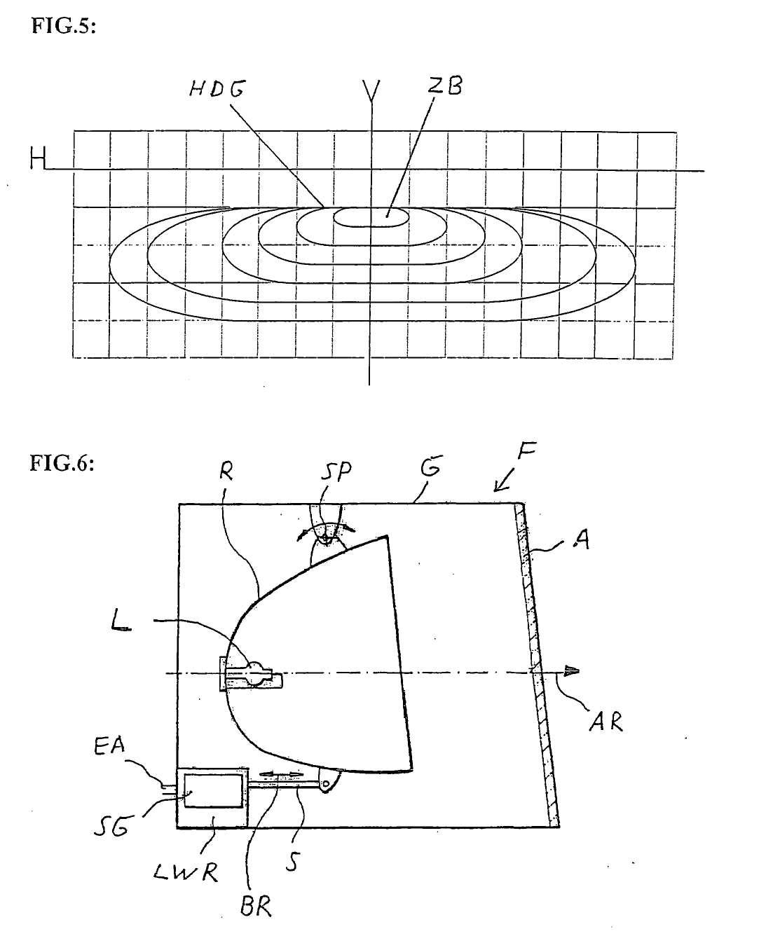

In FIG. 6, a reflector headlight (F) is illustrated, which can generate the light distribution of the present invention. Typically, headlights such as these are arranged in the vehicle as a pair. In special embodiments, however, a plurality of such headlights can complement the forming of the light distribution of the present invention. The vehicle headlight (F) includes a housing (G) and a cover disk (A). In the vehicle headlight (F), a reflector (R) having a light source (L) is arranged. Typically, the reflector (R) is a free surface reflector for the optimum utilization of the light emitted by the light source (L). In order for the beam direction (AR) of the reflector (R) to be adjusted vertically in accordance with the light distributions as described in FIGS. 1 to 5, the reflector is positioned above a swivel point (SP) in the housing (G) and is moved via a headlight leveling device (LWR) and a cam follower (S) in the direction of motion (BR). This motion leads to a vertical adjustment of the light distribution. The activation of the headlight leveling device (LWR) is done via electrical connections (EA), which in its most simple design can be connected to a light switch for pre-selecting the individual light functions. However, the activation of the headlight leveling device (LWR) can also be done automatically. As shown here, a control device (SG) can be arranged in the headlight or even in the vehicle for this purpose, which from switch and sensor signals generates control signals for the activation and adjustment of the headlight leveling device (LWR). Dynamic and driving-condition dependent parameters of the vehicle can hereby be taken into consideration to assure an optimum adjustment of the light distribution. The activation can also be carried out via a bus (bar) of the electrical distribution system of the vehicle (not shown here). At least partly profiled cover disks (A) and/or common reflector geometries can also be used to form the light distribution. The various light functions can also be generated by relative movements of the light source (L) to the reflector (R).

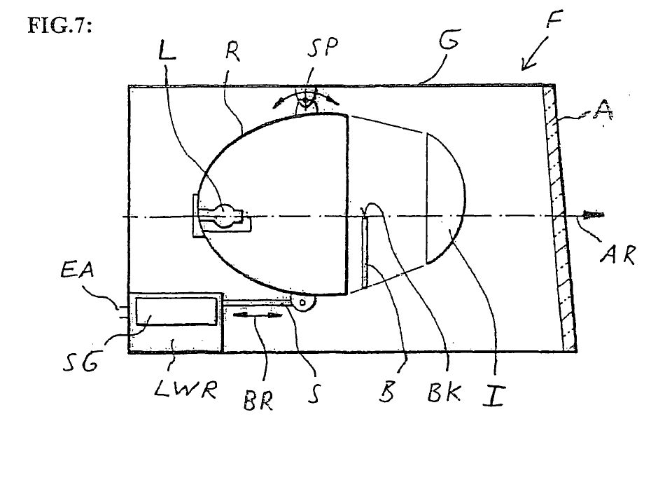

In FIG. 7, a projector headlight (F) is illustrated, which can generate the described light distribution. The same reference symbols as in FIG. 6 are used. The vehicle headlight (F) thereby includes a housing (G) and a cover disk (A) sealing the housing (G). Due to its different functional principle, the vehicle headlight (F) includes a reflector (R) with a light source (L) arranged in the housing (G). The light of the reflector (R) is imaged via a shield edge (BK) of a shield (B) through a lens (I) in the direction of the beam (AR). The reflector (R) is positioned as one unit with the lens (I) and the shield (B) in the housing (G) above a swivel point (SP). A headlight leveling device (LWR) shifts the reflector (R) via a cam follower (S) in the direction of motion (BR). The headlight leveling device (LWR) is identical with the one described in FIG. 6 and can be activated manually or automatically. In addition, it can have a control device (SG), and it has electrical terminals (EA). Because in a projector headlight (F), the shield edge (BK) is imaged as the bright-dark-border (HDG), the various light functions can also be illustrated solely by vertically adjusting the shield edge (BK).

The illustrated headlight constructions are exemplary only. Depending on the requirements, various attachments and control elements can be applied. Different light sources and lighting systems can also be used. For example, it is possible to generate the analogous light distributions with LED light sources in combination with reflectors or lenses, or to construct headlights using optical fiber technology, whereby the light emerging from the optical fiber ends is imaged via reflectors or lenses.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. Light distribution for the headlights of a vehicle, the vehicle headlight including an optical element imaging the light of a light source, a housing, and a transparent cover disk, the light distribution including a bright-dark-border and various light functions being generated by adjusting the light distribution, wherein:
in an area of a roadway that is to be illuminated, the bright-dark-border is essentially horizontal,
the light distribution in a central area directly below the substantially horizontal bright-dark-border has a high intensity,
the bright-dark-border of the light distribution is substantially symmetrical, and
various light functions are generated by a vertical adjustment of the light distribution.

2. The light distribution according to claim 1, wherein, in the central area, the spread of the light distribution is more horizontal than vertical.

3. The light distribution according to claim 2, wherein the central area of the light distribution has a horizontal extension of at least five degrees.

4. The light distribution according to claim 3, wherein the central area of the light distribution has a horizontal extension of less than 15 degrees.

5. The light distribution according to claim 4, wherein the central area is formed by at least two vehicle headlamps that complement each other in the light distribution.

6. The light distribution according to claim 1, wherein, for activating the various light functions, a headlight leveling device, which adjusts the light distribution vertically, is provided to the vehicle headlight.

7. The light distribution according to claim 6, wherein the headlight leveling device can be activated manually.

8. The light distribution according to claim 6, wherein the headlight leveling device can be activated automatically.

9. The light distribution according to claim 6, wherein the headlight leveling device is connected to a control device which generates control signals from switch and sensor signals for the headlight leveling device.

10. The light distribution according to claim 6, wherein the headlight leveling device is activated dynamically and in dependence from the driving condition.

11. The light distribution according to claim 6, wherein the headlight leveling device is activated via an electrical bus in the vehicle.

12. The light distribution according to claim 1, wherein, in an outer area, the bright-dark-border of the light distribution is extending in an upward direction.

13. The light distribution according to claim 12, wherein, in the outer area, the light distribution expands in a downward direction.

14. The light distribution according to claim 1, wherein the light distribution has a horizontal width, which eliminates the need for an adjustment device that moves the light distribution horizontally.

15. The light distribution according to claim 1, wherein the at least one vehicle headlamp is a reflector headlight of a projector headlight.

16. The light distribution according to claim 1, the light distribution provides high beam light, dipped light for left- and right-hand traffic with or without active cornering illumination, and fog light, depending on the adjusted vertical height in relation to the horizontal zero line.
